(19) United States
(12) Patent Application Publication
(10) Pub. No.: US 2007/0052330 A1
(43) Pub. Date: Mar. 8, 2007

(54) Stackable cabinet structure

(76) Inventor: Chien-Kuo Chang, Taichung City (TW)

Correspondence Address: CHARLES E. BAXLEY, ESQUIRE, SUITE 309, 90 JOHN STREET, NEW YORK, NY, 10038, US

(21) Appl. No.: 11/223,199

(22) Filed: Sep. 8, 2005

(51) Int. Cl. F16B 12/00

(52) U.S. Cl. 312/111

(57) ABSTRACT

A stackable cabinet structure includes at least one cabinet body, being a hollow cabinet body and having a space therein for storing objects, and the cabinet body includes a connecting section at the bottom of the cabinet body; and a plurality of support legs, each having a fixing end movably installed to the connecting section of the cabinet body, such that the cabinet body can be connected to the support legs to form a standalone cabinet or stacked with several other cabinets as a whole cabinet by the connecting sections.

### BACKGROUND OF THE INVENTION

1. Field of the Invention

The present invention relates to a cabinet structure, and more particularly to a cabinet structure having detachable support legs, so that the cabinet can be used as a standalone cabinet or stacked with each other.

2. Description of the Related Art

A traditional cabinet usually includes a hollow cabinet body and a plurality of fixed support legs disposed at the bottom of the cabinet body for heightening the bottom of the cabinet body and preventing insects and moisture. However, the prior art cabinet structure comes with a fixed height and capacity, and thus it is necessary to manufacture the cabinets with a single size or several different specifications for the user's choice. However, users may not be able to find the size that fits their needs.

### SUMMARY OF THE INVENTION

Therefore, it is a primary objective of the present invention to provide a stackable cabinet structure, wherein a connecting section is disposed at the bottom of,a cabinet body for movably installing a plurality of support legs to combine several cabinets into one cabinet, and the cabinet bodies can be stacked one on top of the other to increase the capacity of the cabinet, or several cabinets can be stacked into one cabinet of different heights to fit different environments. As to the manufacturing, only one specification is needed produce cabinets of different specifications.

To achieve the foregoing objective and overcome the shortcomings of the prior art, the present invention provides a stackable cabinet structure comprising: at least one cabinet body, being a hollow cabinet body and having a space therein for storing objects, and the cabinet body includes a connecting section disposed at the bottom of the cabinet body; and a plurality of support legs, each having a fixing end movably installed to the connecting section of the cabinet body; such that the cabinet body can be connected to the support legs to form a standalone cabinet or stacked with several other cabinets to form one cabinet by the connecting sections.

### BRIEF DESCRIPTION OF THE DRAWINGS

FIG. 1 is a perspective view of disassembled parts of the present invention;

FIG. 2 is a perspective view of the present invention;

FIG. 3 is a schematic view of installing a support leg according to the invention;

FIG. 4A is a perspective view of another preferred embodiment of the invention;

FIG. 4B is another perspective view of another preferred embodiment of the invention;

FIG. 5 is a perspective view of disassembled parts of a support leg of another preferred embodiment of the invention;

FIG. 6 is a perspective view of a support leg of another preferred embodiment of the invention; and

FIG. 7 is a schematic view of a support leg of another preferred embodiment of the invention.

### DETAILED DESCRIPTION OF THE PREFERRED EMBODIMENTS

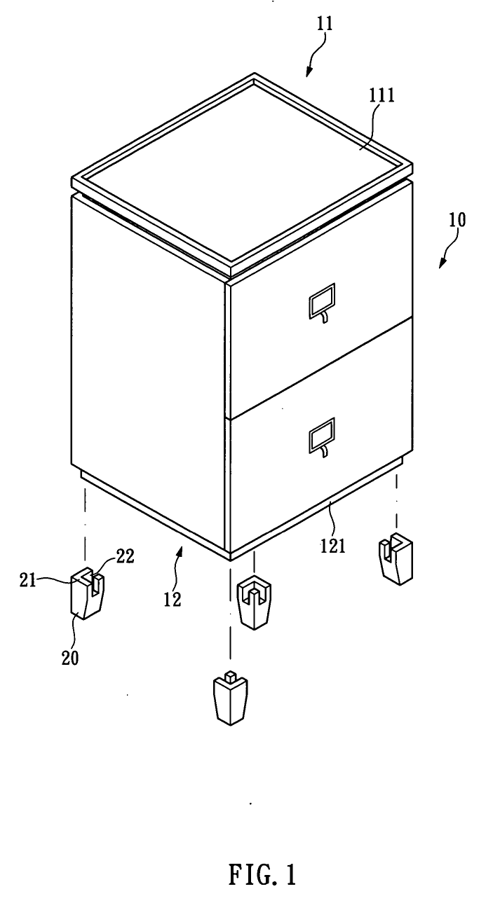

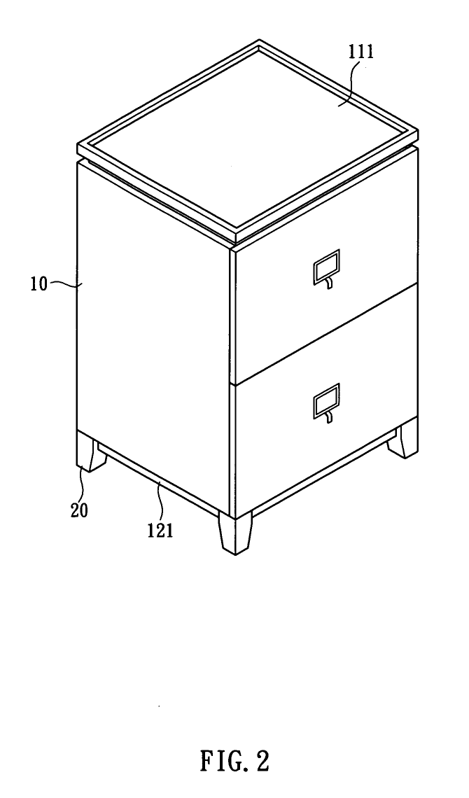

Referring to FIGS. 1 and 2, a stackable cabinet structure, comprises:

at least one cabinet body 10, being a hollow cabinet body and having several partitioned spaces, and the partitioned spaces include components such as a drawer or a pulling door for storing objects, and the cabinet body 10 has a stacking section 11 disposed at the top of the cabinet body 10 and a connecting section 12 disposed at the bottom of the cabinet body 10; wherein the connecting section 12 is a connecting frame 121, and the connecting frame 121 could be a rectangular hollow frame, and the stacking section 11 is an embedding groove 111 having a shape corresponding to the connecting frame 121; and

a plurality of support legs 20, each having a fixing end 21 thereon, and the fixing end 21 corresponding to a fixing groove 22 disposed at each corner of the connecting frame 121, and the fixing groove 22 is sunk into two adjacent surfaces at the internal side of the support leg 20 to form a groove bent with 90 degrees, and the fixing groove 22 of the support leg 20 is inserted into each corner of the connecting frame 121, so that each support leg 20 is movably installed at the four corners of the connecting frame 121 to heighten the bottom of the cabinet body 10 in order to achieve the effect of preventing insects and moisture.

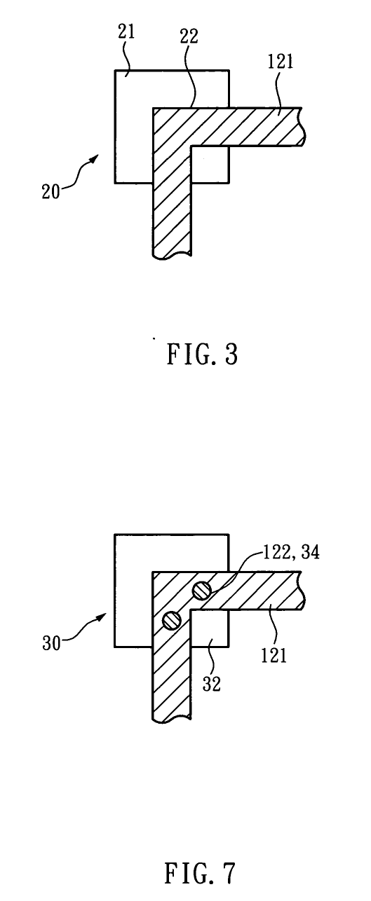

Referring to FIG. 3 for the present invention, the width of the fixing groove 22 is equal to the thickness of the connecting frame 121, and the fixing groove 22 is in the same shape as the corner of the connecting frame 121. When the connecting frame 121 is inserted into the fixing groove 22, the walls of the fixing groove 22 can clamp the connecting frame 121. By the connecting frame 121 and the fixing groove 22, a user can movably install a support leg to each of the four corners at the bottom of the cabinet body 10 to evenly support the weight of the cabinet body 10.

Referring to FIG. 4A for another preferred embodiment, the cabinet body 10 has an embedding groove 111 disposed at the top of the cabinet body 10, such that another cabinet body 10′ can be stacked onto the cabinet body 10 with the support leg 20, so that the connecting frame 121′ at the bottom of the upper cabinet body 10′ is embedded into the embedding groove 111 of the lower cabinet body 10 to increase the overall capacity of the cabinet as shown in FIG. 4A. Several cabinet bodies 10 can be combined to form one cabinet of a different height to fit different environments. As to the cabinet manufacturer, a single specification can meet the requirements of different specifications, and thus the invention is a very convenient design.

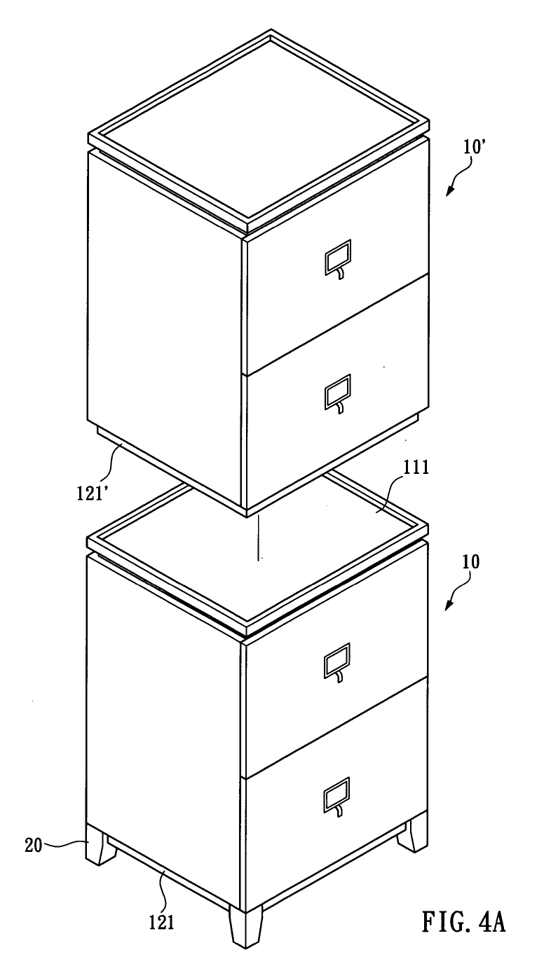

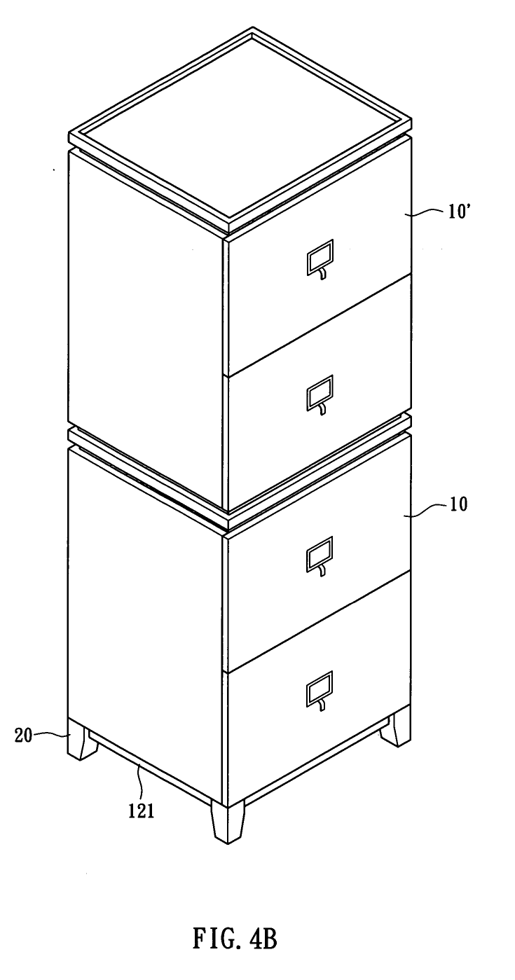

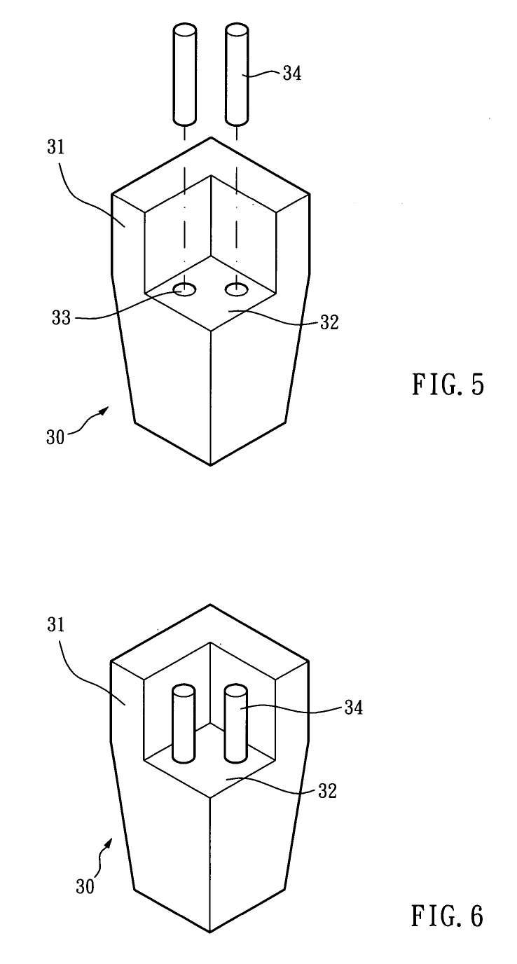

Referring to FIGS. 5 and 6 for the support leg 30 according to another preferred embodiment, the support leg 30 has a fixing groove 32 disposed at the internal side of the fixed end 31, and two adjacent surfaces proximate to the internal side of the fixing groove 32 are open. The fixing groove 32 further includes at least two insert holes 33 at the bottom of the fixing groove 32 for inserting an insert pin 34, and the connecting frame 121 has a plurality of fixing holes 122, each disposed at the bottom of each corner of the connecting frame 121 and corresponding to the insert pin 33.

Referring to FIG. 7, the insert pin 34 is inserted into the corresponding fixing hole 122, when the corners of the connecting frame 121 are inserted into the support legs 30, so that a user can movably install a support leg to the each of the four corners at the bottom of the cabinet body 10, and the groove wall of the fixing groove 32 and the two insert pins 34 separately press the edges of the corner of the connecting frame 121 to provide a force that can evenly support the weight of the cabinet body 10.

In summation of the above description, the present invention herein complies with the patent application requirements and is submitted for patent application. However, the description and its accompanied drawings are used for describing preferred embodiments of the present invention, and it is to be understood that the invention is not limited thereto. To the contrary, it is intended to cover various modifications and similar arrangements and procedures, and the scope of the appended claims therefore should be accorded the broadest interpretation so as to encompass all such modifications and similar arrangements and procedures.

What is claimed is:

1. A stackable cabinet structure, comprising:
at least one cabinet body, being a hollow cabinet body and having a space therein for storing an object, and said cabinet body further comprising a stacking section disposed at the top of said cabinet body and a connecting section disposed at the bottom of said cabinet body; and
a plurality of support legs, each having a fixing end movably inserted into said connecting section of said cabinet body.

2. The stackable cabinet structure of claim 1, wherein said connecting section is a connecting frame.

3. The stackable cabinet structure of claim 2, wherein said connecting frame is a rectangular hollow frame.

4. The stackable cabinet structure of claim 3, wherein said stacking section is in a shape corresponding to an embedding groove of said connecting frame.

5. The stackable cabinet structure of claim 3, wherein said fixing end includes a fixing groove corresponding to said connecting frame.

6. The stackable cabinet structure of claim 5, wherein said fixing groove is sunk from two adjacent surfaces at the internal side of said support leg and bent into 90 degrees.

7. The stackable cabinet structure of claim 6, wherein said fixing groove of said support leg has a width equal to the thickness of said connecting frame, so that said support leg is inserted into each corner of said connecting frame.

8. The stackable cabinet structure of claim 5, wherein said fixing groove is a rectangular open groove and includes at least two insert pins therein.

9. The stackable cabinet structure of claim 8, wherein said fixing groove includes an insert hole at the bottom of said fixing groove for inserting said insert pin.

10. The stackable cabinet structure of claim 9, wherein said connecting frame includes a fixing hole corresponding to said insert pin.
